(19) United States
(12) Patent Application Publication
(10) Pub. No.: US 2009/0278029 A1
(43) Pub. Date: Nov. 12, 2009

(54) PICKUP DEVICE

(75) Inventors: Masakazu Ogasawara, Saitama (JP); Takuma Yanagisawa, Saitama (JP); Makoto Sato, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Meguro-ku (JP)

(21) Appl. No.: 12/441,839

(22) PCT Filed: Nov. 1, 2006
(86) PCT No.: PCT/JP2006/321856

§ 371 Date: Mar. 18, 2009

(51) Int. Cl. G02B 27/40; G02B 27/64

(52) U.S. Cl. 250/201.5

(57) ABSTRACT

A pickup device includes an irradiation optical system containing an objective lens for forming a spot by converging a light beam onto a track of a recording surface of an optical recording medium having a plurality of laminated recording layers; and a detection optical system containing a photodetector for receiving, through the objective lens, return light which was reflected and returned from the spot to perform a photoelectric conversion, in which a position of the objective lens is controlled in response to an electric signal arithmetically operated from an output of the photodetector. The photodetector includes a plurality of photosensing element groups which are arranged away from each other on a plane to which an optical axis of the return light penetrates perpendicularly and each of the groups is composed of a plurality of photosensing elements. The pickup device further comprises a dividing element disposed on another plane to which the optical axis of the return light penetrates perpendicularly. The dividing element has: at least two division regions which are formed so as to be line-symmetrical with respect to a track directional line which intersects with the optical axis of the return light and extends in parallel with the track; at least two division regions which are formed so as to be line-symmetrical with respect to a track vertical line which intersects with the optical axis of the return light and extends in the direction perpendicular to the track; and a center division region which includes the optical axis of the return light and is formed so as to be point-symmetrical with respect to the optical axis of the return light. The dividing element divides the return light into a plurality of partial light beams at respective division regions to deflecting the partial light beams from the division regions other than the center division region to the photosensing element groups.

### TECHNICAL FIELD

The invention relates to an optical pickup device in a recording and reproducing apparatus of an optical recording medium such as an optical disc and, more particularly, to an optical pickup device for controlling an optimum focusing position of a light beam which is focused onto a predetermined recording surface of an optical recording medium such as an optical disc having a plurality of laminated recording layers.

### BACKGROUND ART

In recent years, an optical disc is widely used as means for recording and reproducing data such as video data, audio data, or computer data. A high density recording type disc called a Blu-ray™ Disc (hereinbelow, abbreviated to BD) has been put into practical use. A multilayer optical disc of a laminate structure having a plurality of recording layers is included in an optical disc standard. In the multilayer optical disc in which a plurality of recording surfaces are alternately laminated through spacer layers, in order to read information from one of the surface sides by an optical pickup device, it is necessary to focus a focal point (in-focus position or optimum focusing position) of a light beam onto the recording surface in one desired layer, that is, irradiate a focused light spot onto the desired recording layer.

As shown in FIG. 1, a double-layered optical disc as an example has a layer-1 (hereinbelow, also referred to as L1) of a recording layer as a translucent film of the first layer on this side when seen from the reading side and a layer-0 (hereinbelow, also referred to as L0) of the recording layer of the second layer as a reflecting film made of a metal, a dielectric material, or the like. A light transmitting spacer layer for separating the recording layers so as to have a predetermined thickness is provided between L0 and L1.

When the spacer thickness is large, for example, if the focal point is set to the target L1, since a laser beam which is focused to the L0 is largely widened, reflection light from the L0 becomes a DC-like signal without being modulated by a pit. When high band components are extracted from the read signal by a high pass filter, therefore, only the signal from the L1 can be read out. When the spacer thickness is small, however, even if the focal point is set to the L1, since the laser beam which is irradiated to the L0 is not so widely spread, the signal from the L0 leaks to a certain extent (this leakage is called an interlayer crosstalk).

In order to set the focal point to a desired recording layer of the multilayer optical disc, a focusing error signal is formed and servo control (focusing pull-in) is made. To prevent a focusing offset, however, it is necessary to eliminate an influence such as an interlayer crosstalk from the focusing error signal.

Even if the interlayer crosstalk was suppressed, however, while the reflection light (signal light) in the case where the laser beam has been focused to the target L1 is still guided to a photodetector by an objective lens, the reflection light (stray light) of the light which passed through the target L1 and was widened by the L0 also enters the photodetector as a stray light in a state where it has a predetermined extent.

The stray light other than the signal light interferes with the signal light, becomes a cause of noises, and becomes a big problem which causes an inconvenience such as deterioration in quality of an output signal of the photodetector or offset of a servo error signal.

Hitherto, as shown in FIG. 2, there has been known a pickup construction in which emission light from a light source 11 is converted into parallel light by a collimator lens 53, thereafter, is transmitted through a polarization beam splitter 52 and a quarter-wave plate 54, and is focused onto an information recording surface of an optical storing medium 41 by an objective lens 56, the light reflected there is transmitted through the objective lens 56, thereafter, is reflected by the polarization beam splitter 52, passes through a beam dividing element 64, a detecting lens 59, and a cylindrical lens 57, and enters a photodetector 32. In a detection optical system of the pickup, there has also been proposed a construction for avoiding such a phenomenon that by inserting the beam dividing element 64, in the case of the multilayer optical disc having a plurality of information recording surfaces, unnecessary light enters a photosensing element which is used to detect a TE signal and the TE signal fluctuates (refer to Patent Document 1, paragraphs (0188) to (0192) (embodiment 13)).

Patent Document 1: Japanese patent kokai No. 2004-281026

### DISCLOSURE OF INVENTION

### Problem to be Solved by the Invention

FIG. 3 shows abeam dividing element BDE for separating reflection light from an optical disc. The beam dividing element comprises three-split regions: two regions B1 and B2 for allowing partial light beams including push-pull components (what are called overlap regions where the plus and minus 1st-order light and the 0th-order light which have been diffracted by a track overlap) in a passing light beam to pass; two regions B3 and B4 for allowing partial light beams hardly including the push-pull components to pass; and a center division region w including an optical axis.

In the detection optical system of the pickup in the related art shown in FIG. 2, in the case where the beam dividing element BDE in FIG. 3 is arranged in place of the beam dividing element 64, as shown in FIG. 4, divided diffracted light DL from the beam dividing element BDE is deflected in substantially the same direction except for the center division region w and received by independent photosensing elements, respectively. Photosensing element groups PD1 and PD2 each constructed by four photosensing elements are arranged so as to be away from each other by such a distance that stray light L0t and L1t of the 0th-order light and the 1st-order light are not mixed.

According to the pickup in the related art, as shown in FIG. 4, at the time of reproducing the L1 of the double-layered optical disc, since the center division region w is deflected in another direction, the stray light L0t is not mixed to the photosensing element groups PD1 and PD2 of the diffracted light. In the case of reproducing the L0 layer, as shown in FIG. 5, since the beam dividing element BDE is arranged near a position where the stray light L1t from the L1 layer is concentrated, almost all of the light beam arrives at the center division region w. The stray light L1t is, thus, deflected to a position where it does not enter any of the photosensing elements of the photosensing element group PD2 excluding the photosensing element group PD1. Even if the double-layered optical disc is recorded and reproduced, thus, since the stray light from another layer does not enter the photosensing element group for detection of a tracking error signal, the tracking error signal can be detected.

A problem occurs, however, in the case where the beam dividing element BDE is arranged at the position of a beam dividing element 61 shown in Patent Document 1 (paragraph (0130), (embodiment 6)). A pickup in the related art in the case is shown in FIG. 6. In the pickup, the emission light from the light source 11 is converted into the parallel light by the collimator lens 53, thereafter, is transmitted through the polarization beam splitter 52, beam dividing element 61, and quarter-wave plate 54, and is focused onto the information recording surface of the optical storing medium 41 by the objective lens 56, the light reflected there is transmitted through the objective lens 56, thereafter, is reflected by the polarization beam splitter 52, passes through the detecting lens 59 and cylindrical lens 57, and enters the photodetector 32. That is, in the case where the double-layered optical disc is reproduced, when reproducing the L1 of the double-layered optical disc, although a state is almost similar to that shown in FIG. 4, when reproducing the L0, as shown in FIG. 7, if the beam dividing element 61 is arranged near the objective lens 56, the stray light from the L0 is not sufficiently concentrated upon reproducing L1, so that it cannot be deflected in the center division region w. The stray light from the L1, consequently, enters the photosensing element group PD1 for detection of the tracking error signal and the good tracking error signal cannot be obtained.

According to the dividing element layout in the related art, the elements have to be arranged in the regions where the reflection light from the optical disc has been converged to a small size to a certain extent and there is a problem in positioning of the elements and reliability.

The invention, therefore, intends to provide a pickup device which can maintain quality of a reproduction signal based on signal light from a multilayer recording medium as an example.

### Means for Solving the Problem

According to claim 1, there is provided a pickup device comprising:

an irradiation optical system containing an objective lens for forming a spot by converging a light beam onto a track of a recording surface of an optical recording medium having a plurality of laminated recording layers; and

a detection optical system containing a photodetector for receiving, through the objective lens, return light which was reflected and returned from the spot to perform a photoelectric conversion, in which a position of the objective lens is controlled in response to an electric signal arithmetically operated from an output of the photodetector,

wherein the photodetector includes a plurality of photosensing element groups which are arranged away from each other on a plane to which an optical axis of the return light penetrates perpendicularly and each of the groups is composed of a plurality of photosensing elements,

the pickup device further comprising:

a dividing element disposed on another plane to which the optical axis of the return light penetrates perpendicularly and having:
at least two division regions which are formed so as to be line-symmetrical with respect to a track directional line which intersects with the optical axis of the return light and extends in parallel with the track;
at least two division regions which are formed so as to be line-symmetrical with respect to a track vertical line which intersects with the optical axis of the return light and extends in the direction perpendicular to the track; and
a center division region which includes the optical axis of the return light and is formed so as to be point-symmetrical with respect to the optical axis of the return light,

wherein the dividing element divides the return light into a plurality of partial light beams at respective division regions to deflect the partial light beams from the division regions other than the center division region to the photosensing element groups.

It is preferable that the diffracted partial light beams, which are caused from the division regions being formed so as to be line-symmetrical with respect to a track directional line which intersects with the optical axis of the return light and extends in parallel with the track, include overlap regions where plus and minus 1st-order light and 0th-order light which have been diffracted by the track in the return light overlap each other, wherein the plurality of photosensing element groups are a plurality of photosensing element groups for individually receiving the overlap regions and other regions on the plane to which the optical axis of the return light penetrates perpendicularly, and wherein the photosensing element groups are arranged in different directions while setting the optical axis of the return light to a central reference.

It is preferable that the plurality of photosensing element groups are three photosensing element groups arranged on the optical axis and at both ends of an L-character so as to be away from each other in the L-character shape while setting the optical axis to a reference on the plane to which the optical axis of the return light penetrates perpendicularly, and wherein one of the two photosensing element groups arranged at the both ends of the L-character receives the partial light beam including the overlap regions, and the other one of the two photosensing element groups arranged at both ends of the L-character receives the partial light beam which does not include the overlap regions.

It is preferable that an opening angle from one photosensing element group arranged at a center of the optical axis to the two photosensing element groups arranged at both ends of the L-character lies within a range from 80° to 100°.

It is preferable that one photosensing element group arranged at the center of the optical axis is arranged on the optical axis of the return light and the every two photosensing element groups arranged at both ends of the L-character from the one photosensing element group arranged at the center of the optical axis are arranged on a straight line which intersects with the optical axis of the return light and extends in the direction of the deflection by the dividing element.

It is preferable that the device has an arithmetic operating unit which is connected to the two photosensing element groups arranged at both ends of the L-character and arithmetically operates a tracking error signal from their outputs.

It is preferable that the one photosensing element group arranged at the center of the optical axis receives the light beam of the return light on which the dividing element does not act and has an arithmetic operating unit which is connected to the photosensing elements and arithmetically operates a focusing error signal from their outputs.

It is preferable that in the case of reproducing a target recording layer, the photosensing element group is disposed at a position where the reflection light from a non-target layer does not enter.

It is preferable that the dividing element is a split polarization hologram element for changing an action for diffracting and deflecting in accordance with a polarizing direction of the passing light beam.

### BRIEF DESCRIPTION OF DRAWINGS

FIG. 1 Schematic cross sectional view of a double-layered optical disc.

FIG. 2 Schematic diagram showing a construction of an optical pickup device.

FIG. 3 Schematic plan view showing a beam dividing element in the optical pickup device.

FIG. 4 Schematic plan view showing a photodetector in the optical pickup device.

FIG. 5 Schematic plan view showing the photodetector in the optical pickup device.

FIG. 6 Schematic diagram showing a construction of the optical pickup device.

FIG. 7 Schematic plan view showing the photodetector in the optical pickup device.

FIG. 8 Schematic diagram showing a construction of an optical pickup device of an embodiment according to the invention.

FIG. 9 Schematic plan view showing an astigmatism element in the optical pickup device of the embodiment according to the invention.

FIG. 10 Schematic plan view showing a quadrant photosensing element group in a photodetector in an optical pickup device of another embodiment according to the invention.

FIG. 11 Schematic plan view showing a split polarization hologram element in the optical pickup device of the embodiment according to the invention.

FIG. 12 Schematic plan view showing the photodetector in the optical pickup device of the embodiment according to the invention.

FIG. 13 Schematic plan view showing the photodetector in the optical pickup device of the embodiment according to the invention.

FIG. 14 Schematic plan view showing the photodetector in the optical pickup device of the embodiment according to the invention.

FIG. 15 Schematic plan view showing a split polarization hologram element in an optical pickup device of another embodiment according to the invention.

FIG. 16 Schematic plan view showing a photodetector in an optical pickup device of another embodiment according to the invention.

FIG. 17 Schematic plan view showing a photodetector in an optical pickup device of another embodiment according to the invention.

FIG. 18 Schematic plan view showing a photodetector in an optical pickup device of another embodiment according to the invention.

FIG. 19 Schematic plan view showing a photodetector in an optical pickup device of another embodiment according to the invention.

FIG. 20 Schematic plan view showing a split polarization hologram element in an optical pickup device of another embodiment according to the invention.

FIG. 21 Schematic plan view showing a split polarization hologram element in an optical pickup device of another embodiment according to the invention.

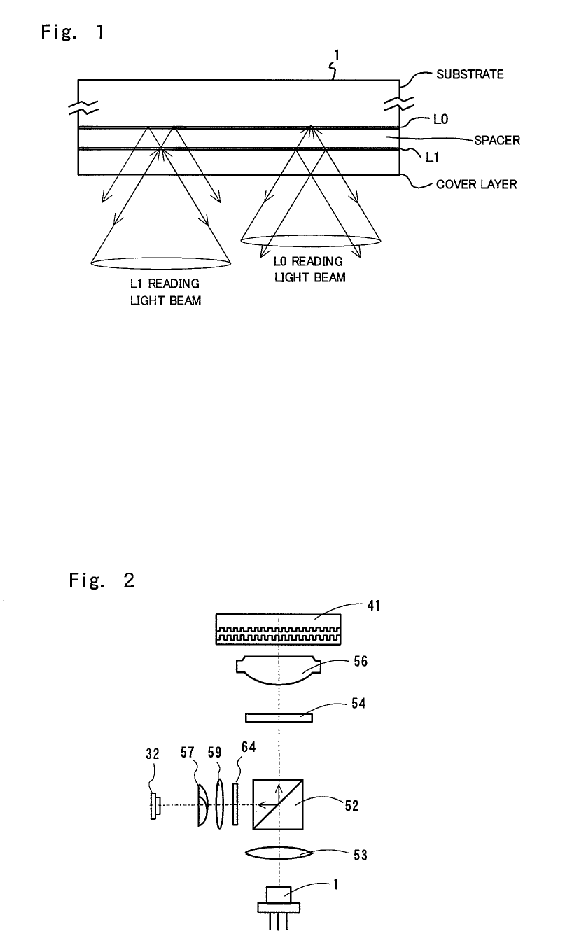

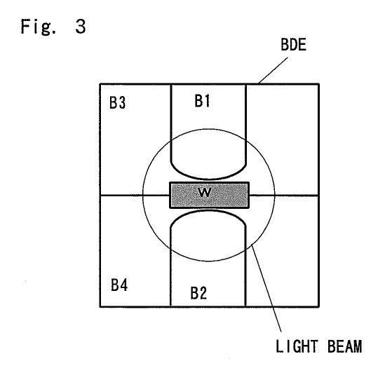

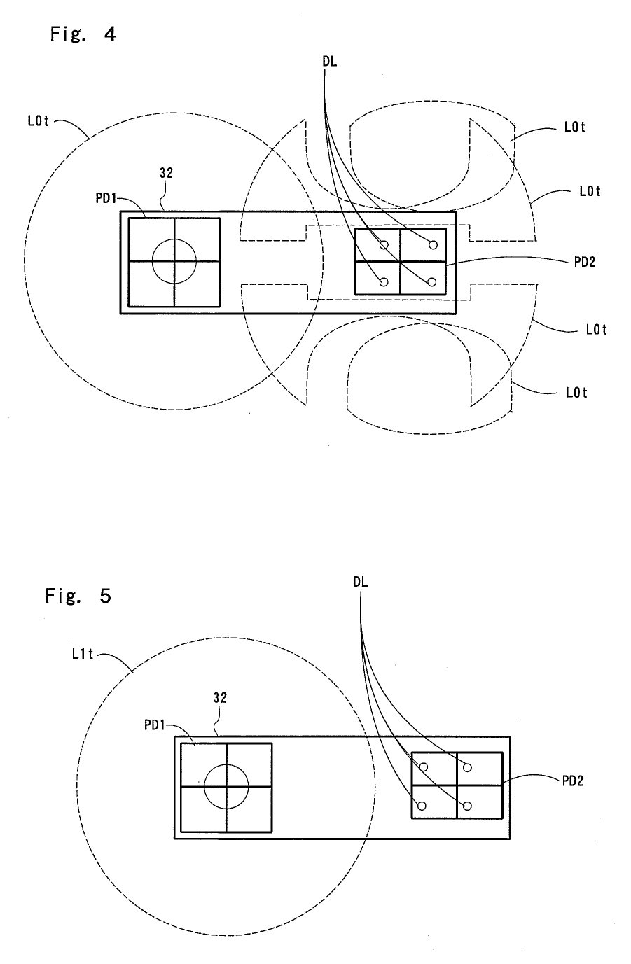

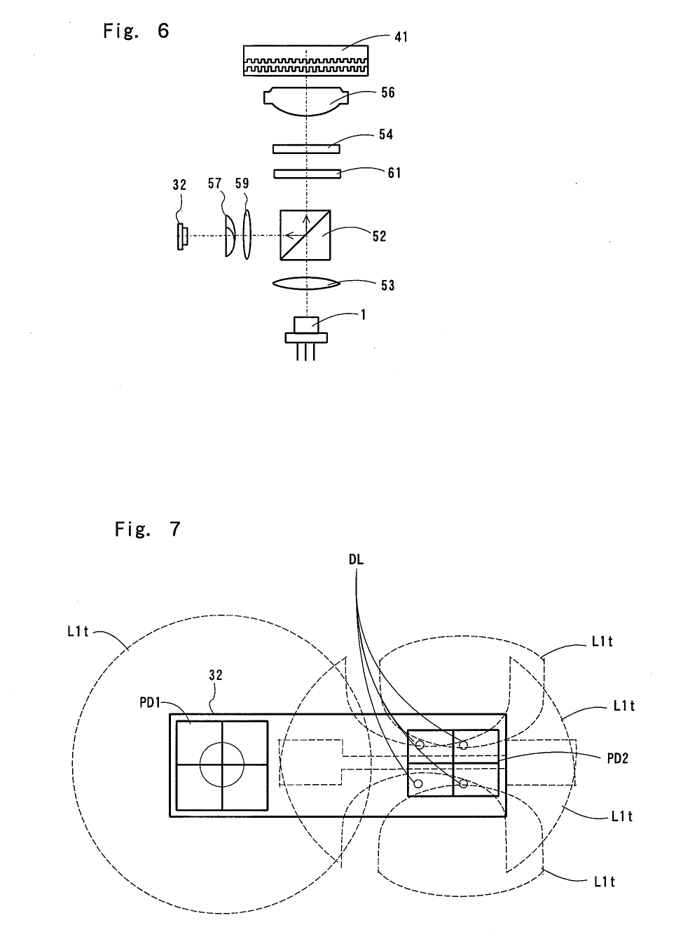

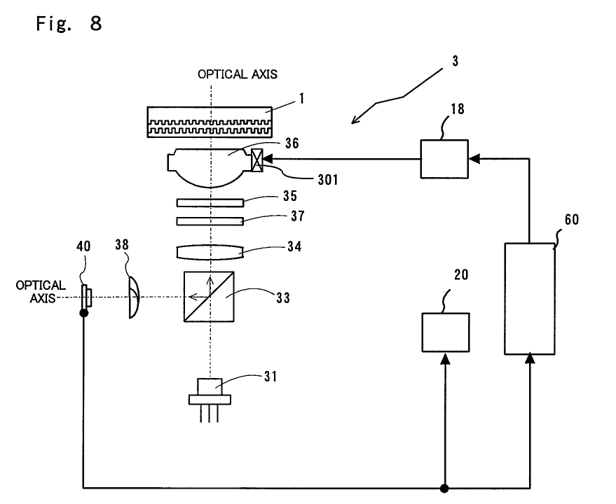

### DESCRIPTION OF REFERENCE NUMERALS

1. Optical disc
3. Pickup
18. Driving circuit
31. Semiconductor laser
33. Polarization beam splitter
34. Collimator lens
35. Quarter-wave plate
36. Objective lens
38. Astigmatism element
37. Split polarization hologram element
40. Photodetector
20. Demodulating circuit
60. Servo control unit
400. quadrant photosensing element group
401. Radial sub-photosensing element group
402. Tangential sub-photosensing element group
B1, B2, B3, B4, B5, B6, B7, B8. Photosensing element

### MODE FOR CARRYING OUT THE INVENTION

An optical pickup device of an embodiment in the invention will be described hereinbelow with reference to the drawings.

FIG. 8 shows a schematic construction of an optical pickup device 3 of the embodiment. The optical pickup device has: a semiconductor laser 31 as a light source; a polarization beam splitter 33; a collimator lens 34 (optical element for correcting a thickness error of an optical disc) for converting divergent light into parallel light; a split polarization hologram element 37; a quarter-wave plate 35; an objective lens 36; an astigmatism element 38; and a photodetector 40. The split polarization hologram element 37 as a dividing element is arranged in a return optical system between the objective lens 36 and the collimator lens 34.

An optical disc 1 is an optical recording medium having a plurality of recording layers laminated through spacer layers and is disposed on a turntable (not shown) of a spindle motor so as to be away from the objective lens 36.

The objective lens 36 for forming a spot by converging a light beam onto a target recording surface of the optical disc 1 is included in an irradiation optical system. The objective lens 36 is movably supported in order to execute focusing servo and tracking servo operations and its position is controlled by an electric signal which has been arithmetically operated from an output of the photodetector 40. The objective lens 36 also belongs to a detection optical system for receiving return light which was reflected and returned from the spot and guiding it to the photodetector 40 through the quarter-wave plate 35, split polarization hologram element 37, and polarization beam splitter 33.

The polarization beam splitter 33 has a polarizing mirror and divides an optical path of the passing light in a different direction according to a polarizing state of the passing light. The light beam focused onto a signal surface track on the optical disc 1 by the objective lens 36 is reflected and enters the objective lens 36. The return light beam which enters the objective lens 36 passes through the quarter-wave plate 35 and the split polarization hologram element 37, is separated from the irradiation optical system by the polarization beam splitter 33, and becomes linear polarization light. The return light beam reaches the photodetector 40 through the astigmatism element 38.

The astigmatism element 38 arranged between the polarization beam splitter 33 and the photodetector 40 applies an astigmatism, thereby performing the focusing servo (astigmatism method). The astigmatism is an aberration that is caused since a focal distance of a lens optical system contains an optical axis and has different values on two cross sectional planes which cross perpendicularly each other. When the light is converged by the optical system having the astigmatism, a formed image changes to a vertically elongated shape, a circular shape, and a laterally elongated shape depending on a position on the optical axis. It is also possible to design in such a manner that the split polarization hologram element 37 and the astigmatism element 38 are reversely arranged and after the return light was diffracted, the astigmatism is applied.

The objective lens 36 for forming the spot by converging the light beam onto the target recording surface of the optical disc 1 is included in the irradiation optical system. The objective lens 36 is movably supported by an actuator 301 in order to execute the focusing servo and tracking servo operations and its position is controlled by a connected driving circuit 18 on the basis of the electric signal which has been arithmetically operated from the output of the photodetector 40. The objective lens 36 also belongs to the detection optical system for receiving the return light which was reflected and returned from the spot and guiding it to the photodetector 40 through the beam splitter 33.

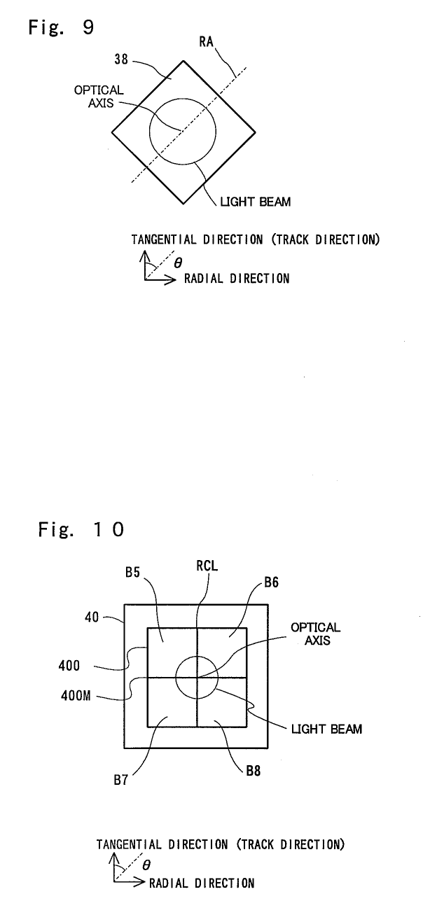

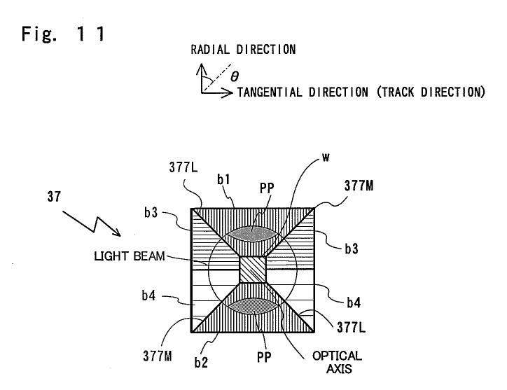

For example, a multi-lens including a cylindrical surface can be used as an astigmatism element 38. FIG. 9 is a schematic plan view showing the multi-lens including the cylindrical surface as an example of the astigmatism element 38. As illustrated in the diagram, the lens is arranged so as to cross the optical axis of the return light in such a manner that on the plane to which the optical axis of the return light penetrates perpendicularly, its center axis RA (rotation symmetrical axis of a cylindrical curved surface forming a ridge line or a lens surface of a cylindrical lens) extends at an angle of θ=45° for the direction perpendicular to the radial direction of the optical disc 1, that is, for the track direction. The extending direction of the center axis RA of the cylindrical lens of the astigmatism element 38 is an astigmatism direction. The astigmatism element 38 arranged in the return optical system is a part of focusing error signal forming means.

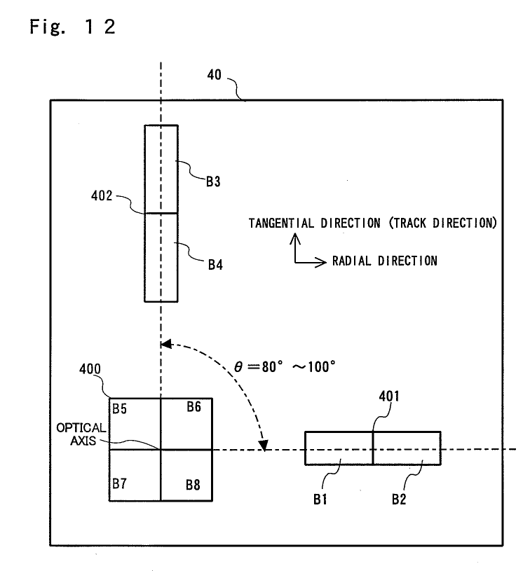

FIG. 10 is a schematic plan view showing a quadrant photosensing element group 400 as a part of the photodetector 40. The quadrant photosensing element group 400 receives the 0th-order light which is not subjected to the deflecting action in the dividing element. The quadrant photosensing element group 400 is constructed by photosensing elements B5, B6, B7, and B8 of four photosensing surfaces having the same area of the first to fourth quadrants which are closely arranged by using two lines RCL and 400M which cross perpendicularly each other as boundary lines and are respectively independent on a plane to which the optical axis of the return light penetrates perpendicularly. They are arranged in such a manner that one line RCL is parallel with the track direction and the lines RCL and 400M intersect with the optical axis of the return light at the intersection thereof. In the invention, the track and the track direction in the detection optical system denote a track and a track direction of a mapping of the track on each element at the time when the detection optical system is driven. The photosensing elements of the photodetector 40 are connected to a demodulating circuit 20 for forming a reproduction signal and to a servo control unit 60 for the spindle motor, slider, and tracking. A photoelectric conversion output from each of the photosensing elements is arithmetically operated and a focusing error signal, a tracking error signal, and the like are formed. The driving circuit 18 is controlled by the servo control unit 60.

As mentioned above, the pickup device 3 has: the irradiation optical system including the objective lens 36 for forming a light spot by converging the light beam onto the track of the recording surface of the optical recording medium; and the detection optical system including the photodetector 40 for receiving, through the objective lens 36, the return light which was reflected and returned from the light spot and photoelectrically converting it. The pickup device 3 controls the position of the objective lens 36 by the electric signal arithmetically operated from the outputs of the photosensing elements of the photodetector 40.

The photosensing element groups of the photodetector 40 are not limited to what is called a quadrant photodetector but any photodetector may be used therefor as far as it has at least two photosensing elements formed so as to be line-symmetrical with respect to the line RCL which intersects with the optical axis of the return light and extends in parallel with the track in the detection optical system may be used so long as the tracking error signal of a push-pull signal can be obtained.

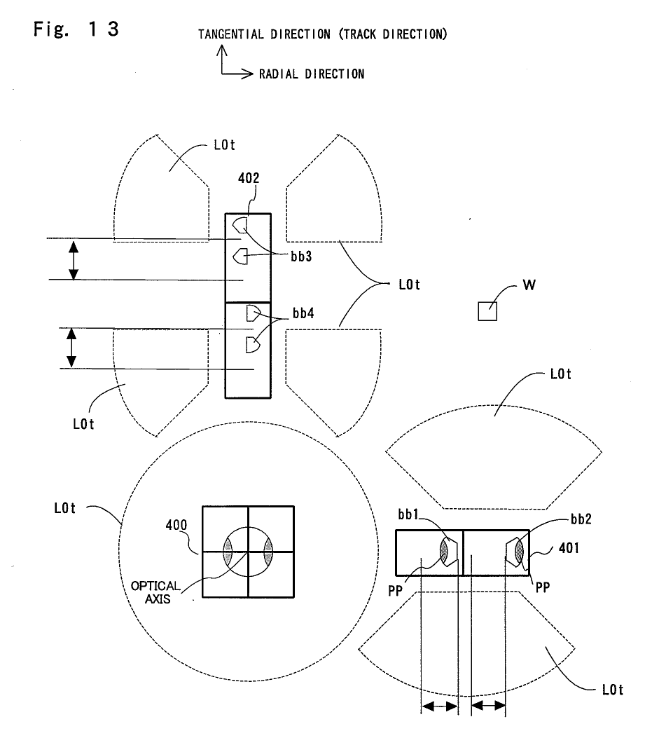

FIG. 11 is a schematic plan view showing the split polarization hologram element 37 of the dividing element. The split polarization hologram element 37 is constructed so that the light beam of the return light is mainly divided into three light beams. That is, the split polarization hologram element 37 is constructed by: a center division region w including the return light optical axis; and division regions b1, b2, and b3 and b4 (a pair of each of b3s and b4s are line-symmetrical) grouped into three regions around an outside circumference of the center division region w. The dividing element is a hologram and a depth of groove of the hologram is set every predetermined division region so that a light amount of the diffracted light is smaller than that of the 0th-order light. The dividing element is a polarization hologram and has the function only in the polarization light of the reflection light from the optical disc. As shown in FIG. 11, boundary lines 377L and 377M of the split polarization hologram element 37 extend at an angle of 45° (astigmatism direction) for the tangential direction of the optical disc. The division regions are arranged so as to cross the return light optical axis in such a manner that the division regions b1 and b2 are arranged in the radial direction and the division regions b3 and b4 are arranged in the tangential direction. Since the division regions b3 and b4 arranged in the tangential direction are line-symmetrical in the radial direction and have the same area, they are also used for a tracking push-pull method. That is, the boundary lines 377L and 377M of the split polarization hologram element 37 are divided by a boundary line extending in the direction of the astigmatism (45° for the extending direction of the track) due to the astigmatism element 38 around the return light optical axis as a center. As mentioned above, the split polarization hologram element 37 is constructed by: the at least two division regions formed so as to be line-symmetrical with respect to a track directional line which intersects with the optical axis of the return light and extends in parallel with the track; the at least two division regions formed so as to be line-symmetrical with respect to a track vertical line which intersects with the optical axis of the return light and extends in the direction perpendicular to the track; and the center division region which includes the optical axis of the return light and is formed so as to be point-symmetrical with respect to the optical axis of the return light.

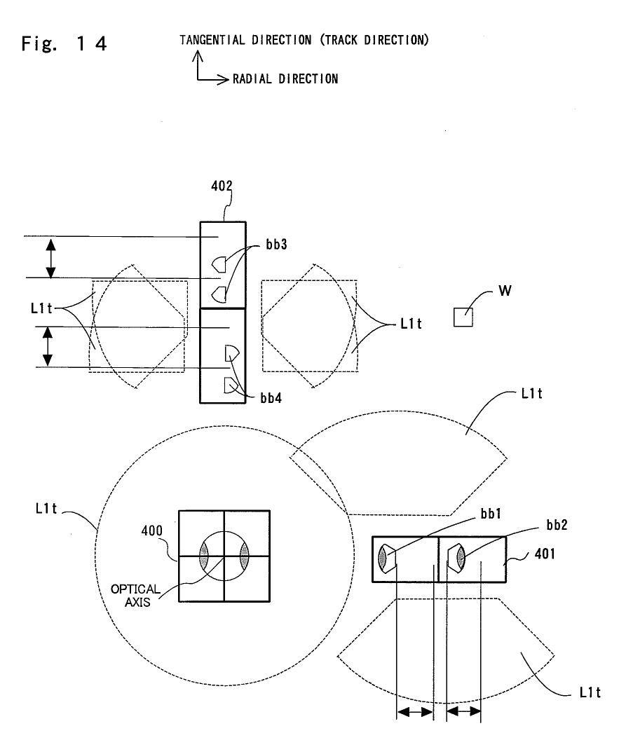

As shown in FIG. 12, the whole photodetector 40 has: the quadrant photosensing element group 400 for the 0th-order diffracted light in FIG. 10 provided on the return light optical axis in order to perform the focusing servo using the astigmatism method; and further, radial and tangential sub-photosensing element groups 401 and 402 which are juxtaposed in the radial and tangential directions respectively and opened at angles of about 90° from the quadrant photosensing element group 400 on one side. The sub-photosensing element groups 401 and 402 are arranged in an L-character shape around the quadrant photosensing element group 400 on the optical axis as a center and are away from each other in such a manner that partial light beams from the neighboring division regions of the split polarization hologram element 37 do not mutually interfere on those photosensing element groups.

The radial sub-photosensing element group 401 is constructed by two photosensing elements B1 and B2 which are juxtaposed in the radial direction and divided in the radial direction. The tangential sub-photosensing element group 402 is constructed by two photosensing elements B3 and B4 which are juxtaposed in the tangential direction and divided in the tangential direction. The photosensing element groups are formed long and thin in the deflecting directions due to the split polarization hologram element 37, that is, along the radial and tangential directions.

As shown in FIGS. 11 and 13, in the case of reproducing the L1 of the double-layered optical disc, the split polarization hologram element 37 divides the reflection return light beam from a converging spot on the track of the recording surface of the optical disc into three regions and deflects the light components (center division region w) on the optical axis, the region diffracted light components in the radial direction (division regions b1 and b2), and the region diffracted light components in the tangential direction (division regions b3 and b4) to the different directions, respectively. Partial light beams bb3 and bb4 in the tangential region and partial light beams bb1 and bb2 in the radial region are diffracted in the directions which differ by about 90°, respectively. Each of the light beam in the tangential region and the light beam in the radial region is further divided into two regions by the dividing element and received by the independent photosensing elements. Those photosensing element groups are away from the 0th-order optical axis of the return light by such a distance that the stray light from another layer L0 of the 0th-order light which is not diffracted by the polarization hologram is not mixed. The division region w of the split polarization hologram element 37 is provided to prevent the center portion of the return light from being irradiated to the radial and tangential sub-photosensing element groups 401 and 402 as much as possible and is formed so that transmitted light W is diffracted, for example, from the return light optical axis to a direction of an angle of 45° from the tangential direction in FIG. 13. Or, the center division region w of the split polarization hologram element 37 can be also formed as a light shielding region made of an absorbing material. In the case, although the center portion of the 0th-order light is shielded against the light, if the center region is set to be small, the reproduction of an RF signal is not obstructed.

The division regions b1 and b2 shown in FIG. 11 are line-symmetrical patterns, are juxtaposed in the radial direction so as to sandwich the center division region w, and are formed so as to respectively diffract and deflect the partial light beams toward the photosensing elements B1 and B2 of the radial sub-photosensing element group 401 in FIG. 13. As shown in FIG. 13, therefore, the partial light beams bb1 and bb2 of the diffraction light diffracted in the division regions b1 and b2 of the split polarization hologram element 37 become two symmetrical deformed half circles on the photosensing elements B1 and B2 of the radial sub-photosensing element group 401.

The division regions b3 and b4 shown in FIG. 11 are line-symmetrical patterns, are juxtaposed in the tangential direction so as to sandwich the center division region w, and are formed so as to respectively diffract and deflect the partial light beams toward the photosensing regions B3 and B4 of the tangential sub-photosensing element group 402. As shown in FIG. 13, therefore, the partial light beams bb3 and bb4 diffracted in the division regions b3 and b4 of the split polarization hologram element 37 become two deformed quarter circles on the photosensing elements B3 and B4 of the radial sub-photosensing element group 401.

By the construction of the photodetector shown in FIG. 12, by using output signals B1, B2, B3, B4, B5, B6, B7, and B8 of the photosensing elements B1, B2, B3, B4, B5, B6, B7, and B8 of the quadrant photosensing element group 400 and the radial and tangential sub-photosensing element groups 401 and 402, a focusing error signal FE of the following equation: FE=(B5+B8)−(B6+B7), a push-pull tracking error signal TE of the following equation: TE=(B1−B2)−k(B4−B3), and an RF signal RF of the following equation: RF=B5+B6+B7+B8 are obtained, respectively. In the equations, k denotes a differential coefficient.

### Embodiment 1

A case of reproducing the L1 layer of the double-layered optical disc will be described as an example.

A light beam emitted from the semiconductor laser 31 as a light source in FIG. 8 passes through the polarization beam splitter 33 and reaches the collimator lens 34. The collimator lens 34 can set off an aberration caused by a thickness error of the optical disc 1 by a mechanism which moves in the optical axial direction. The light beam passed through the collimator lens 34 enters the split polarization hologram element 37. Since the split polarization hologram element 37 does not cause any action in the polarization of the outward light beam, the light beam enters the quarter-wave plate 35 as it is, passes through the objective lens 36, is reflected by the signal surface of the optical disc, and enters the quarter-wave plate again. The light beam passed through the quarter-wave plate 35 is subjected to the action of the split polarization hologram element 37 because its polarizing direction differs from that of the outward light beam by 90°. The split polarization hologram element 37 changes the diffracting and deflecting actions in accordance with the polarizing direction of the passing light beam.

As shown in FIG. 13, while the 0th-order light of the return light is left on the optical axis, the split polarization hologram element 37 divides the diffracted light into the partial light beams bb1, bb2, bb3, and bb4 and deflects them so that the every two light beams are arranged in series in each deflecting directions. The light beams bb1 and bb2 in the radial region and the light beams bb3 and bb4 in the tangential region are deflected in the directions which differ by about 90°. Both of the light beams W in the center division region are deflected in the different directions or distances (for example, directions of 45°), respectively.

Since the groove depth of the hologram of the split polarization hologram element 37 has been set so that the light amount of the diffracted light is smaller than that of the 0th-order light, the reflection light which has been reflected from the optical disc and transmitted through the split polarization hologram element 37 is divided into six light beams including the 0th-order light (if the −1st-order light is also included, eleven light beams). Those light beams are reflected by the polarization beam splitter 33 and enter the photodetector 40.

In the photodetector 40, since four photosensing elements B1, B2, B3, and B4 for receiving the diffracted light (+1st-order light) excluding the transmitted light W of the center division region divided by the split polarization hologram element 37 are independently provided, the tracking error signal is formed by using outputs of them. As for the tracking error signal, a push-pull tracking error signal is formed by using the light beams bb1 and bb2 (B1, B2) in the radial region including track diffraction components PP (what are called overlap regions where the plus and minus 1st-order light and the 0th-order light diffracted by the track overlap) of the optical disc. A lens shift of the objective lens is detected by using the light beams bb3 and bb4 (B3, B4) in the tangential region without any track diffraction. By arithmetically operating those signals by the arithmetic operating equations, a push-pull tracking signal in which an offset due to the lens shift has been cancelled can be obtained.

The 0th-order light which is not subjected to the deflecting action in the split polarization hologram element 37 is received by the quadrant photosensing element group 400 and a focusing error signal is obtained by the astigmatism method or the like and added, thereby obtaining an RF signal. It is, therefore, preferable that the diffracted partial light beams from the division regions formed so as to be line-symmetrical with respect to the track directional line which intersects with the optical axis of the return light and extends in parallel with the track include the overlap regions where the plus and minus 1st-order light and the 0th-order light diffracted by the track in the return light overlap, one of the two photosensing element groups arranged at both ends of the L-character receives the partial light beams including the overlap regions, and the other one of the two photosensing element groups arranged at both ends of the L-character receives the partial light beams which do not include the overlap regions.

It has been set so that the light beams in the center division region w of the split polarization hologram element 37 do not enter any of the photosensing elements.

In the case of reproducing the L1 layer of the optical disc 1, an interlayer crosstalk from the L0 layer is irradiated as stray light L0t onto the photodetector 40. As shown in FIG. 13, the stray light L0t of the 0th-order light is widened almost in a circular shape around the optical axis as a center. Since the photosensing element groups which receive the diffracted light are sufficiently away from the optical axis by such a distance that the stray light of the 0th-order light does not enter, it does not detect the stray light of the 0th-order light. As shown in FIG. 13, since the stray light L0t of the diffracted light has distribution without the center division region w, both of the photosensing element groups in the radial direction and the tangential direction do not receive the stray light. It is, therefore, preferable that a plurality of photosensing element groups are the three photosensing element groups arranged at the optical axis center and at both ends of the L-character so as to be away from each other in the L-character shape on the plane to which the optical axis of the return light penetrates perpendicularly, and that the dividing elements and the photodetector are set so that the diffracted partial light beams from the mutually neighboring division regions of the dividing element do not interfere on the photosensing element groups.

In the pickup construction of the embodiment, the split polarization hologram element 37 is arranged between an optical element for correcting the thickness error of the optical disc and the objective lens. In the case, when a lens group (collimator lens 34) moves in the optical axial direction in order to correct the thickness error, a magnification of the detection system changes. The diffraction light diffracted by the split polarization hologram element 37, thus, moves in the deflecting directions (arrows in FIG. 13). In the embodiment, however, the photosensing element groups which receive the diffracted light are set to be long and thin in the deflecting directions by the dividing element, that is, along the radial and tangential directions, even if the collimator lens 34 moves, no photosensing leakage occurs. The deflecting direction is separated into the radial direction and the tangential direction by 90°, so that a gap occurs between the deflecting directions of the diffracted light of the stray light. Even if the collimator lens 34 moves and the diffracted light and the stray light move, therefore, since no stray light exists in the moving direction, they are not mixed into the surplus photosensing element groups.

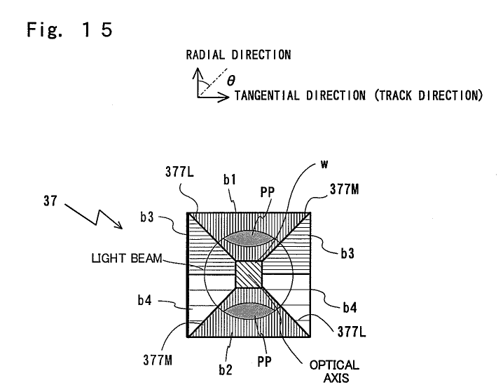

In the case of reproducing the L0 layer, an interlayer crosstalk from the L1 layer is irradiated as stray light onto the photodetector. As shown in FIG. 14, the stray light L1t of the 0th-order light is widened almost in a circular shape around the optical axis as a center. The stray light L1t of the diffracted light appears on the side opposite to that at the time of the L0 layer reproduction. However, the stray light does not enter in excess into the photosensing element groups. This is because a gap occurs between the deflecting directions of the diffracted light of the stray light in a manner similar to the case of the L0 layer reproduction, even if the collimator lens 34 moves and the diffracted light and the stray light move, since no stray light exists in the moving direction. Likewise, the diffracted light does not overflow from the photosensing element groups either.

### Embodiment 2

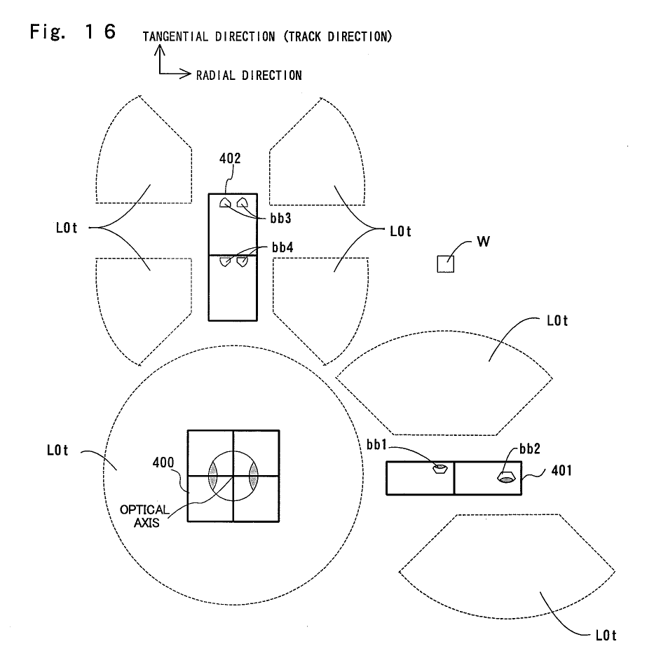

As shown in FIG. 15, a dividing element (split polarization hologram element 37) in the embodiment 2 is formed so as to have not only the division deflecting action of the dividing element in the embodiment 1 but also an action for setting off the astigmatism which is caused by the astigmatism forming optical element and a lens action for forming a substantial converging point on the photosensing element group.

In the dividing element 37 in the embodiment 2, a hologram for cancelling the action of the cylindrical lens used in the astigmatism method in the detection system and a hologram having such a lens action that at the position of the photosensing element group, the diffracted light forms a converging spot which is sufficiently smaller than the spot in the embodiment 1 without those actions are added to the split polarization hologram element in the embodiment 1. Other constructions and functions of the pickup are similar to those in the embodiment 1.

The return light coming from the optical disc passes through the dividing element 37, so that it is divided into diffracted light and 0th-order light in five regions. The diffracted light is subjected to the deflecting actions of the holograms, cylindrical lens action, and a condenser lens action, so that a spot smaller than that in the embodiment 1 is formed onto the photosensing surface. Since there is a surplus in size of the photosensing element group for receiving the diffracted light, therefore, the size of the photosensing element group can be reduced. An optical system which is also strong against an optical axis deviation or the like due to an adjustment error or an aging change can be formed.

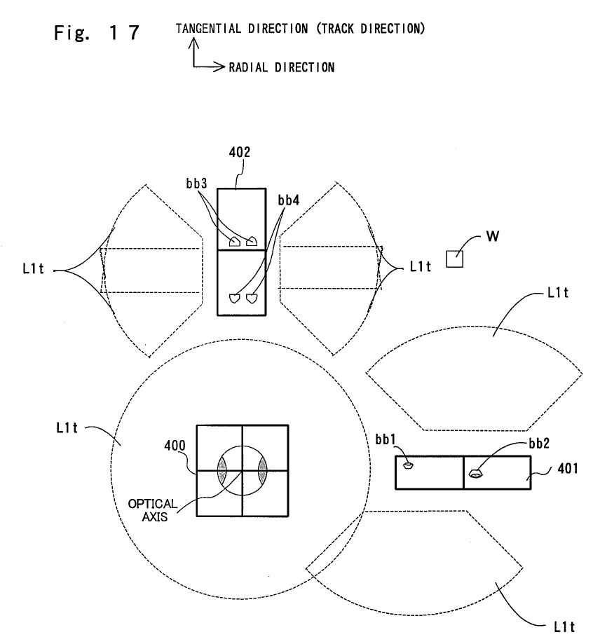

Also in the embodiment 2, as shown in FIG. 16, the dividing element 37 divides the reflection light beam from the optical disc into three regions, deflects the center division region on the optical axis, the region in the radial direction of the optical disc, and the region in the tangential direction of the optical disc to the different directions, and deflects the light beam in the tangential region and the light beam in the radial region in the directions which differ by about 90°, respectively. Also in the case of reproducing the L1 layer of the optical disc 1, an interlayer crosstalk from the L0 layer is irradiated as stray light L0t onto the photodetector 40. As shown in FIG. 16, the stray light L0t of the 1st-order light is widened almost in a circular shape around the optical axis as a center. Since the photosensing element groups which receive the diffracted light are sufficiently away from the optical axis by such a distance that the stray light of the 0th-order light does not enter, they do not detect the stray light of the 0th-order light. Since the stray light L0t of the diffracted light has distribution without the center division region w, both of the photosensing element groups in the radial direction and the tangential direction do not receive the stray light. A case of reproducing the L1 layer of the optical disc 1 is shown in FIG. 17. an operation is executed in a manner similar to that in FIG. 14.

### (Modification)

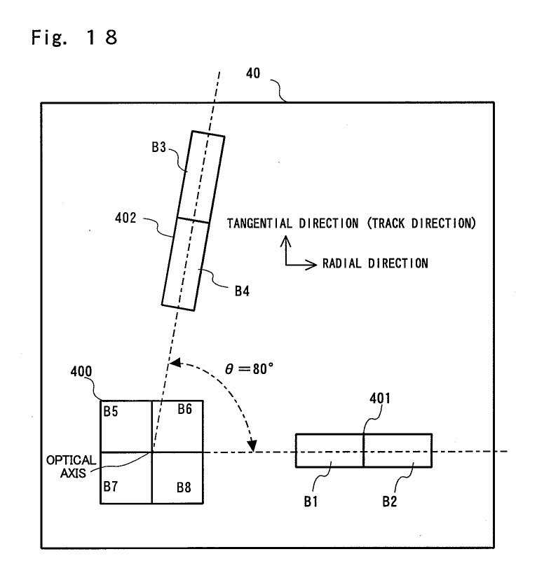

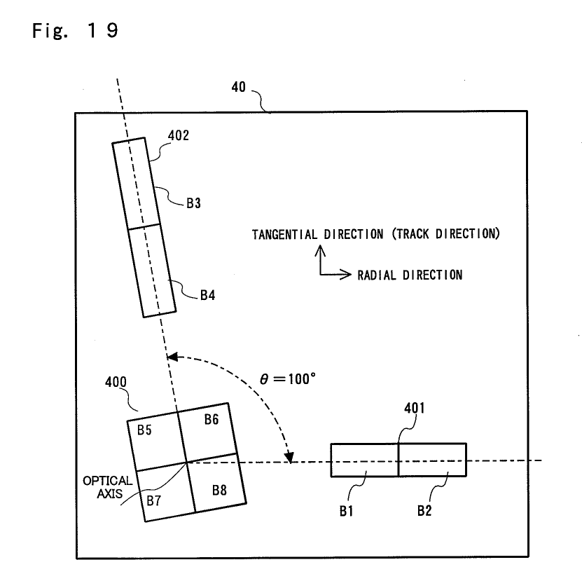

A plurality of photosensing element groups are a plurality of photosensing element groups for individually receiving the overlap regions and other regions on the plane to which the optical axis of the return light penetrates perpendicularly. Fundamentally, it is sufficient that the photosensing element groups are arranged in the different directions while setting the optical axis of the return light to a reference. As shown in FIGS. 18 and 19, an open angle from one photosensing element group 400 arranged at the center of the optical axis of the photodetector 40 to the two photosensing element groups 401 and 402 arranged at both ends of the L-character may be set to θ=80° or θ=100°. An open angle between the photosensing element groups having the L-character layout may be set to 80° to 100°. It is, however, preferable that one photosensing element group arranged at the center of the optical axis is arranged on the optical axis of the return light and, at the same time, the photosensing element groups 401 and 402 arranged at both ends of the L-character from the photosensing element group 400 arranged at the center of the optical axis are arranged on a straight line in the tangential direction and a straight line in the radial direction, respectively.

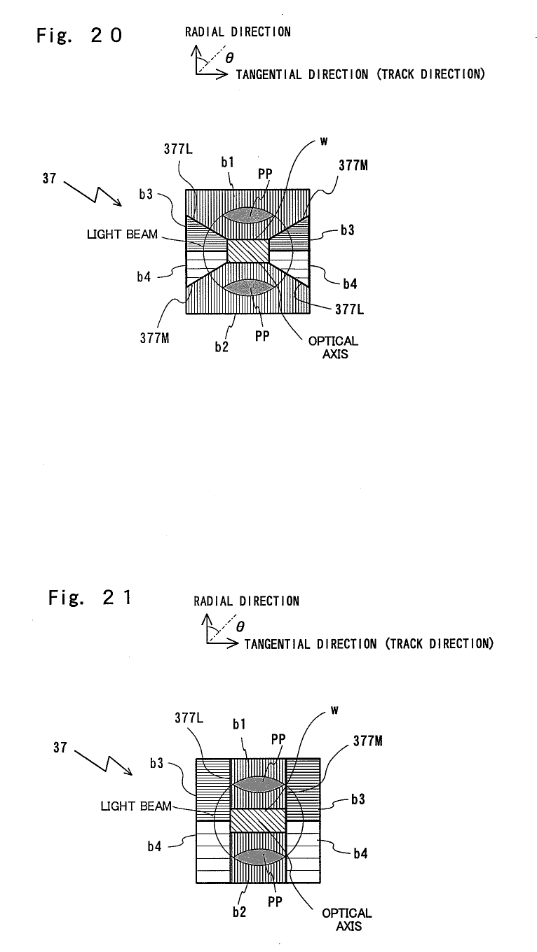

The region dividing element is also not limited to the split polarization hologram element 37 in FIG. 11 but, for example, split polarization hologram elements 37 having dividing patterns as shown in FIGS. 20 and 21 are also considered. W and b1, b2, b3, and b4 regions in FIGS. 20 and 21 correspond to the W and b1, b2, b3, and b4 regions in FIG. 11. As shown in FIG. 20, by extending the boundary lines 377L and 377M of the split polarization hologram element 37 at an angle other than the angle of 45° (astigmatism direction) for the tangential direction of the optical disc and setting the areas of the division regions b1 and b2 to be larger than those in the case of FIG. 11, it is also possible to cope with a transition of the overlap regions of the light beams. On the contrary, it is also possible to construct in such a manner that the areas of the division regions b1 and b2 are set to be smaller than those in the case of FIG. 11, as shown in FIG. 21, the boundary lines 377L and 377M of the split polarization hologram element 37 are extended in parallel in the radial direction of the optical disc, and the division regions are arranged so as to cross the return light optical axis so that the division regions b1 and b2 are arranged in the radial direction and the division regions b3 and b4 are arranged in the tangential direction. That is, in any of the examples, it is desirable to divide the light beam so that the division regions b1 and b2 include the overlap regions where the plus and minus 1st-order light and the 0th-order light which have been diffracted by the track overlap and the division regions b3 and b4 do not include the overlap regions.

1. A pickup device comprising:
an irradiation optical system containing an objective lens for forming a spot by converging a light beam onto a track of a recording surface of an optical recording medium having a plurality of laminated recording layers; and
a detection optical system containing a photodetector for receiving, through the objective lens, return light which was reflected and returned from the spot to perform a photoelectric conversion, in which a position of the objective lens is controlled in response to an electric signal arithmetically operated from an output of the photodetector,
wherein the photodetector includes a plurality of photosensing element groups which are arranged away from each other on a plane to which an optical axis of the return light penetrates perpendicularly and each of the groups is composed of a plurality of photosensing elements,
the pickup device further comprising:
a dividing element disposed on another plane to which the optical axis of the return light penetrates perpendicularly and having:
at least two division regions which are formed so as to be line-symmetrical with respect to a track directional line which intersects with the optical axis of the return light and extends in parallel with the track;
at least two division regions which are formed so as to be line-symmetrical with respect to a track vertical line which intersects with the optical axis of the return light and extends in the direction perpendicular to the track; and
a center division region which includes the optical axis of the return light and is formed so as to be point-symmetrical with respect to the optical axis of the return light,
wherein the dividing element divides the return light into a plurality of partial light beams at respective division regions to deflect the partial light beams from the division regions other than the center division region to the photosensing element groups.

2. A pickup device according to claim 1,
wherein the diffracted partial light beams, which are caused from the division regions being formed so as to be line-symmetrical with respect to a track directional line which intersects with the optical axis of the return light and extends in parallel with the track, include overlap regions where plus and minus 1st-order light and 0th-order light which have been diffracted by the track in the return light overlap each other,
wherein the plurality of photosensing element groups are a plurality of photosensing element groups for individually receiving the overlap regions and other regions on the plane to which the optical axis of the return light penetrates perpendicularly, and
wherein the photosensing element groups are arranged in different directions while setting the optical axis of the return light to a central reference.

3. A pickup device according to claim 2,
wherein the plurality of photosensing element groups are three photosensing element groups arranged on the optical axis and at both ends of an L-character so as to be away from each other in the L-character shape while setting the optical axis to a reference on the plane to which the optical axis of the return light penetrates perpendicularly, and
wherein one of the two photosensing element groups arranged at the both ends of the L-character receives the partial light beam including the overlap regions, and the other one of the two photosensing element groups arranged at both ends of the L-character receives the partial light beam which does not include the overlap regions.

4. A pickup device according to claim 3, wherein an opening angle from one photosensing element group arranged at a center of the optical axis to the two photosensing element groups arranged at both ends of the L-character lies within a range from 80° to 100°.

5. A pickup device according to claim 3, wherein one photosensing element group arranged at the center of the optical axis is arranged on the optical axis of the return light and the every two photosensing element groups arranged at both ends of the L-character from the one photosensing element group arranged at the center of the optical axis are arranged on a straight line which intersects with the optical axis of the return light and extends in a direction of the deflection by the dividing element.

6. A pickup device according to claim 3, further comprising an arithmetic operating unit which is connected to the two photosensing element groups arranged at both ends of the L-character and arithmetically operates a tracking error signal from their outputs.

7. A pickup device according to claim 1, wherein one of the plurality of photosensing element groups is arranged at the center of the optical axis wherein the one photosensing element group receives the light beam of the return light on which the dividing element does not act, the pickup device further comprising an arithmetic operating unit which is connected to the photosensing elements and arithmetically operates a focusing error signal from their outputs.

8. A pickup device according to claim 1, wherein in the case of reproducing a target recording layer, the photosensing element group is disposed at a position where the reflection light from a non-target layer does not enter.

9. A pickup device according to claim 1, wherein the dividing element is a split polarization hologram element for changing an action for diffracting and deflecting in accordance with a polarizing direction of the passing light beam.
